(19) United States
(12) Patent Application Publication
(10) Pub. No.: US 2026/0357992 A1
(43) Pub. Date: Nov. 12, 2026

(54) MICROPHONE MOUNTING ASSEMBLY FOR APPLIANCE

(71) Applicant: Haier US Appliance Solutions, Inc., Wilmington, DE (US)

(72) Inventor: Steven Michael Recio, Louisville, KY (US)

(21) Appl. No.: 19/199,443

(22) Filed: May 6, 2025

(51) Int. Cl. F24C 7/08; H04R 1/04

(52) U.S. Cl. CPC F24C 7/086; H04R 1/04; F24C 7/085

(57) ABSTRACT

Appliance and associated methods for creating and assembling an appliance including a microphone mounting assembly. The appliance includes a cabinet defining a chamber, a cabinet door, and a microphone mounting assembly. The microphone mounting assembly includes a glass panel defining at least one microphone hole slot, a back panel coupled to the glass panel defining a printed circuit board cutout, a printed circuit board configured to receive at least one microphone coupled to the back panel positioned within the printed circuit board cutout, and at least one microphone coupled to the printed circuit board.

### FIELD OF THE INVENTION

The present disclosure relates generally to appliances, and more particularly to microphone mounting assemblies for appliances.

### BACKGROUND OF THE INVENTION

Conventional residential and commercial ovens generally include a cabinet that includes a cooking chamber for receipt of food items for cooking. Multiple gas or electric heating elements are positioned within the cabinet for heating the cooking chamber to cook food items located therein. The heating elements can include, for example, a bake heating assembly positioned at a bottom of the cooking chamber and a separate broiler heating assembly positioned at a top of the cooking chamber.

Typically, food or utensils for cooking are placed on wire racks within the cooking chamber and above the bake heating assembly. In some instances, protective or radiant plates are positioned over the bake heating assembly to protect the bake heating assembly or assist in evenly distributing heat across the bottom of the cooking chamber. Oftentimes, ovens are controlled by a control panel that requires manual and tactile inputs by the user. In some more modern environments, a microphone is included in the control panel assembly to allow for audio inputs by the user.

Although a few assemblies with microphones exist, there are certain disadvantages. For instance, microphones can only be placed in areas that are protected from the heat caused by the oven appliance. In some embodiments, microphones are placed between the door gap and the control panel. However, there is still some exposure to heat when the door is open while the oven appliance is operating. Further, there are microphone holes, which are openings in the glass and can result in debris and other particles becoming lodged in these holes, disrupting the quality of the audio input. Additionally or alternatively, the glass panel overlaying the microphone is often materially thicker than panel assemblies without microphone. This thick glass panel can result in a frosted appearance when viewing the panel from certain angles.

Accordingly, improved microphone mounting assemblies for oven appliances, and appliances generally, and associated methods for mounting microphones on appliances would be useful. More specifically, a microphone mounting assembly and associated methods that can allow for improved aesthetics, acoustics, and minimizing issues with debris and other particles becoming lodges in the holes would be particularly beneficial.

### BRIEF DESCRIPTION OF THE INVENTION

Aspects and advantages of the invention will be set forth in part in the following description, or may be obvious from the description, or may be learned through practice of the invention.

In one example embodiment, an appliance defining a mutually orthogonal vertical direction, lateral direction, and transverse direction is provided. The appliance includes a cabinet defining a cooking chamber, a cabinet door, and a microphone mounting assembly. The microphone mounting assembly includes a glass panel defining at least one microphone hole slot, a back panel coupled to the glass panel defining a printed circuit board cutout, a printed circuit board configured to receive at least one microphone coupled to the back panel positioned within the printed circuit board cutout, and at least one microphone coupled to the printed circuit board positioned within the printed circuit board cutout.

In accordance with another example embodiment, a method for assembling an appliance is provided. The appliance includes a cabinet defining a cooking chamber, a cabinet door, and a microphone mounting assembly including a glass panel defining at least one microphone hole slot, a back panel coupled to the glass panel defining a printed circuit board cutout, a printed circuit board configured to receive at least one microphone coupled to the back panel positioned within the printed circuit board cutout, and at least one microphone coupled to the printed circuit board. The method for assembling an appliance includes providing the glass panel defining at least one microphone hole slot, providing the back panel defining a printed circuit board cutout, positioning the at least one microphone and printed circuit board configured to receive the at least one microphone within the printed circuit board cutout, creating the microphone mounting assembly, and coupling the microphone mounting assembly to the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example oven appliance and a schematic diagram of an external communication system according to one or more embodiments of the present subject matter.

FIG. 2 provides a section view of the example oven appliance of FIG. 1 taken along line 2 -2 of FIG. 1 according to an example embodiment of the present subject matter.

FIG. 3 provides a front perspective view of an example glass panel that may be used in a microphone mounting assembly of example oven appliance of FIG. 1 according to one or more embodiments of the present subject matter.

FIG. 4 provides a back perspective view of an example back panel that may be used in a microphone mounting assembly of example oven appliance of FIG. 1 according to one or more embodiments of the present subject matter.

FIG. 5 provides a side sectional view of an example microphone mounting assembly of example oven appliance of FIG. 1 according to one or more embodiments of the present subject matter.

FIG. 6 provides a partial front perspective view of an example glass panel that may be used in a microphone mounting assembly of example oven appliance of FIG. 1 according to one or more embodiments of the present subject matter.

FIG. 7 provides a partial front perspective view of an example glass panel that may be used in a microphone mounting assembly of example oven appliance of FIG. 1 according to one or more embodiments of the present subject matter.

FIG. 8 illustrates a method for assembling an oven appliance in accordance with one embodiment of the present disclosure.

FIG. 9 illustrates a method for creating a microphone mounting assembly in accordance with one or more embodiments of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and may not be intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. As used herein, the terms “coupled,” “fixed,” “attached to,” and the like refer to both direct coupling, fixing, or attaching, as well as indirect coupling, fixing, or attaching through one or more intermediate components or features, unless otherwise specified herein. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, and as will be described in more detail below, aspects of the present subject matter are generally directed to features for receiving an audio input, in particular from a user. More specifically, a microphone mounting assembly that is embedded within or a part of the user interface panel is provided. In some embodiments, the microphone mounting assembly may take the place of the user interface panel in its entirety. Generally, the microphone mounting assembly allows for at least one microphone to be mounted onto the thin glass panel of the microphone mounting assembly. The thin glass allows for smaller microphone hole slots to avoid debris, food, and other unwanted items from becoming lodged therein.

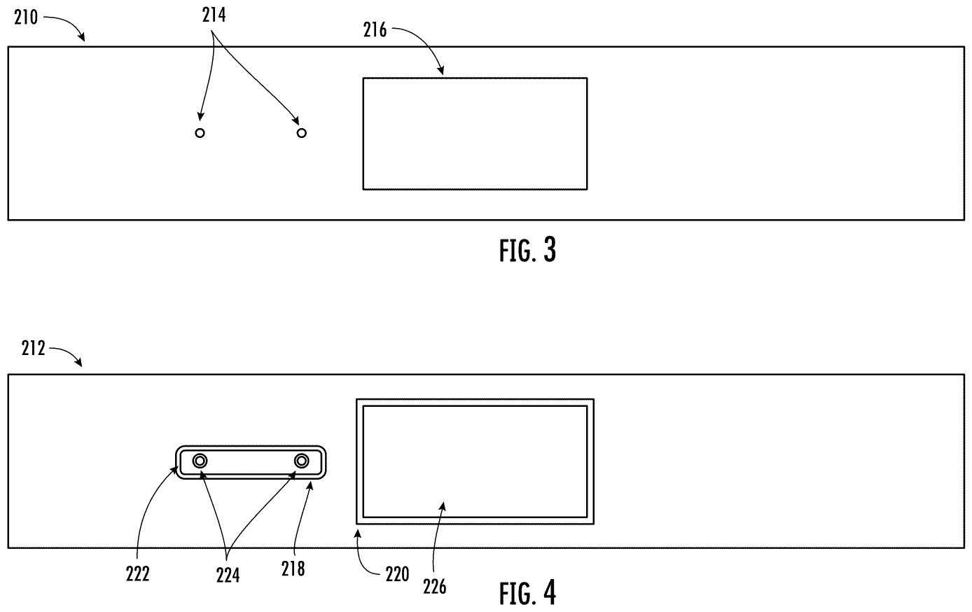

Such features may include one or input devices, e.g., at least one microphone 224 (see, e.g., FIG. 3), or other detection devices that are used to monitor audio surrounding the oven appliance 100, such as an area in which user is accessing the cooking chamber 104 or user is within the general vicinity of the oven appliance 100. The sensors or other input devices may be operable to detect and monitor audio inputs of one or more users that are accessing the oven appliance 100, and in particular the cooking chamber 104 and/or cooktop 150 thereof. In this regard, the oven appliance 100 may use data from each of these devices to obtain a representation or knowledge of the identity and/or voice characteristics of one or more users.

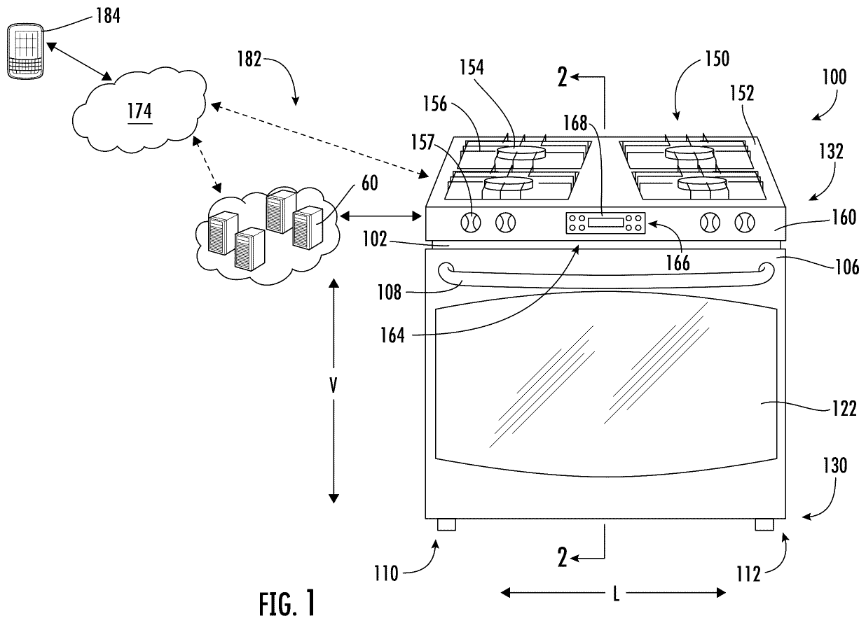

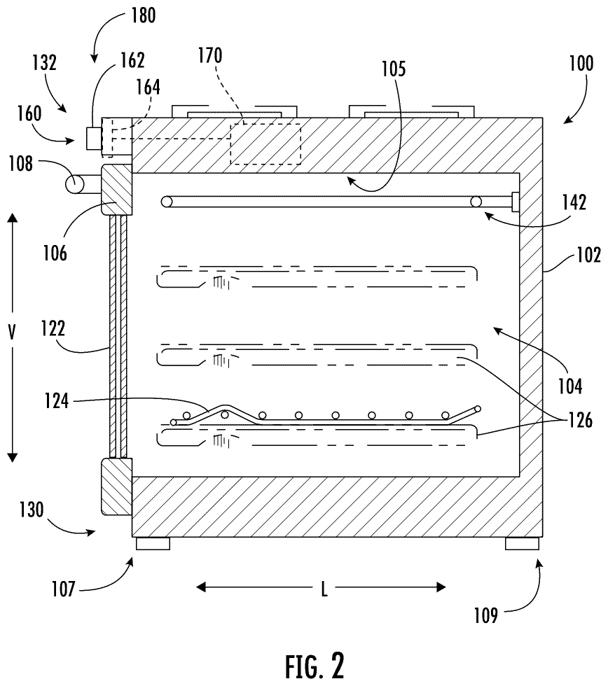

FIG. 1 provides a front perspective view of an oven appliance 100 according to exemplary embodiments of the present subject matter. FIG. 2 provides a section view of exemplary oven appliance 100 taken along line 2-2 of FIG. 1. Oven appliance 100 is shown in FIGS. 1 and 2 as a free-standing range oven appliance, but it will be appreciated that oven appliance 100 is provided by way of example only and is not intended to limit the present subject matter in any aspect. Other cooking appliances having different configurations, different appearances, and/or different features may also be utilized with the present subject matter as well. Thus, the present subject matter may be used with other oven appliance configurations, e.g., wall ovens and/or oven appliances that define one or more interior cavities for the receipt of food items and/or having different pan or rack arrangements than what is shown in FIGS. 1 through 2, as well as with cooktop-only appliances. Moreover, aspects of the present subject matter may be used in any other consumer or commercial appliance where it is desirable to use a microphone mounting assembly within another suitable appliance. Thus, the example embodiment shown in FIGS. 1 through 2 is not intended to limit the present subject matter to any domestic appliance, particular cooking chamber configuration, or arrangement.

Oven appliance 100 includes an insulated cabinet 102 with an interior cooking chamber 104 defined by an interior surface 105 of cabinet 102. Cooking chamber 104 is configured for receipt of one or more food items to be cooked. Cabinet 102 extends between a bottom portion 130 and a top portion 132 along a vertical direction V. Cabinet 102 also extends between a front portion 107 and a back portion 109 along a transverse direction T and between a first side 110 and a second side 112 along a lateral direction L. Vertical direction V, lateral direction L, and transverse direction T are mutually perpendicular and form an orthogonal direction system.

Oven appliance 100 includes a door 106 rotatably mounted to cabinet 102, e.g., with a hinge (not shown). A handle 108 is mounted to door 106 and assists a user with opening and closing door 106. For example, a user can pull or push handle 108 to open or close door 106 to access cooking chamber 104. Oven appliance 100 includes a seal (not shown) between door 106 and cabinet 102 that maintains heat and cooking fumes within cooking chamber 104 when door 106 is closed as shown in FIGS. 1 and 2. Multiple parallel glass panes 122 provide for viewing the contents of cooking chamber 104 when door 106 is closed and provide insulation for cooking chamber 104. A baking rack 124 is positioned in cooking chamber 104 for receipt of food items or utensils containing food items. Baking rack 124 is slidably received onto embossed ribs or sliding rails 126 such that rack 124 may be conveniently moved into and out of cooking chamber 104 when door 106 is open.

A top heating element or broil element 142 is positioned in cooking chamber 104 of cabinet 102 proximate top portion 132 of cabinet 102. Top heating element 142 is used to heat cooking chamber 104 for both cooking/broiling and cleaning of oven appliance 100. Like heating assembly 140, the size and heat output of top heating element 142 can be selected based on, e.g., the size of oven appliance 100. In the exemplary embodiment shown in FIG. 2, top heating element 142 is shown as an electric resistance heating element.

As shown in FIG. 1, oven appliance 100 may include a cooktop 150. Cooktop 150 is disposed on and is attached to or integral with cabinet 102. Cooktop 150 includes a top panel 152, which by way of example may be constructed of glass, ceramics, enameled steel, or combinations thereof. One or more burners 154 extend through top panel 152. A utensil (e.g., pots, pans, etc.) holding food and/or cooking liquids (e.g., oil, water, etc.) may be placed onto grates 156 disposed adjacent burners 154. Burners 154 provide thermal energy to cooking utensils placed on grates 156. Burners 154 can be any suitable type of burners, including e.g., gas, electric, electromagnetic, a combination of the foregoing, etc. It will be appreciated that the configuration of cooktop 150 is provided by way of example only and that other suitable configurations are contemplated. Furthermore, aspects of the present disclosure are not limited to embodiments with the presence of cooktop 150, and FIG. 1 is provided by way of example only. For example, a wall oven may feature aspects of the present embodiment without having a cooktop 150 therein.

Oven appliance 100 includes a user interface panel 160. For this exemplary embodiment, user interface panel 160 includes a number of knobs 162 that each correspond to one of the burners 154. Knobs 162 allow users to activate each burner 154 and to determine the amount of heat input provided by each burner 154 to a cooking utensil located thereon. The user interface panel 160 is located within convenient reach of a user of the oven appliance 100. For this example embodiment, user interface panel 160 includes user inputs 166 that may generally be configured for regulating heating elements 142 or operation of oven appliance 100.

User interface panel 160 also includes a control panel 164 that provides visual information to a user and allows the user to select various operational features for the operation of oven appliance 100 via one or more user inputs 166. One or more of a variety of electrical, mechanical or electro-mechanical input devices including but not limited to rotary dials, push buttons, toggle/rocker switches, and/or touch pads can also be used singularly or in combination as user inputs 166. It will be appreciated that the configuration of user interface panel 160 is provided by way of example only and that other suitable configurations and features are contemplated, e.g., the embodiments in FIGS. 3 through 7 which include a microphone mounting assembly 200.

A display 168 of control panel 164 may also be provided with one or more graphical display devices or display components 168, such as a digital or analog display device designed to provide operational feedback or other information to the user such as, e.g., whether a particular burner 154 is activated and/or the level at which the burner 154 is set. Display 168 can be a touch sensitive component (e.g., a touch-sensitive display screen or a touch pad) that is sensitive to the touch of a user input object (e.g., a finger or a stylus). Display 168 may include one or more graphical user interfaces that allow for a user to select or manipulate various operational features of oven appliance 100 or its cooktop 150. Display 168 may be a display screen, e.g., an LCD screen.

Additionally, user interface panel 160 may be configured to communicate via a controller 170 to an external communication system 182 to interact with at least one consumer device. Although external communication system 182 is illustrated herein as interacting with a single appliance (i.e., oven appliance 100), it should be appreciated that this schematic representation is only intended to facilitate discussion of aspects of the present subject matter. In this regard, for example, external communication system 182 and the methods described herein may be used to simultaneously monitor a plurality of appliances located in the same household or in different locations and/or having different owners. In this regard, for example, although the exemplary appliance is shown as an oven appliance in FIG. 1, it is recognized that the benefits of the present disclosure apply to other types and styles of appliances. For instance, the present disclosure is understood to apply to refrigerator appliances, dishwasher appliances, washing machine appliances, dryer appliances, microwave appliances, air conditioning appliances, etc. Consequently, the description set forth herein is for illustrative purposes only and is not intended to be limiting in any aspect to any particular appliance or configuration.

As illustrated in FIG. 1, a schematic diagram of an external communication system 182 will be described according to an exemplary embodiment of the present subject matter. In general, external communication system 182 is configured for permitting interaction, data transfer, and other communications between oven appliance 100 and one or more external devices (e.g., such as portions of a cloud system). For example, this communication may be used to provide and receive operating parameters, user instructions or notifications, performance characteristics, user preferences (e.g., such as user inputs 166), fault conditions or data, or any other suitable information for improved performance of oven appliance 100. In addition, it should be appreciated that external communication system 182 may be used to transfer data or other information to improve performance of one or more external devices or appliances and/or improve user interaction with such devices.

For example, external communication system 182 permits controller 170 of oven appliance 100 to communicate with a separate device external to oven appliance 100, referred to generally herein as cloud server. In addition, external communication system 182 may permit controller 170 of oven appliance 100 to communicate with a remote device 184, such as a personal phone, a smartphone, a tablet, a laptop or personal computer, a wearable device, a smart home system, or another mobile or remote device. These communications may be facilitated using a wired or wireless connection, such as via a network 174. In general, external communication system, e.g., a cloud server, may be any suitable device separate from oven appliance 100 that is configured to provide and/or receive communications, information, data, or commands from a user. In this regard, the cloud server may be, for example, a cloud-based server located at a distant location, such as in a separate state, country, etc. According to an exemplary embodiment, oven appliance 100 may communicate with cloud server over network 174, such as the Internet, to transmit/receive data or information, provide user inputs, receive user notifications or instructions, interact with or control oven appliance 100, etc. According to exemplary embodiments, cloud server may be configured to receive appliance data and diagnose or predict potential fault conditions, e.g., determining audio sensitivity parameters for microphone(s), providing component checks to microphone(s), and/or providing component checks to the printed circuit board configured to receive the microphone(s).

In general, communication between oven appliance 100, cloud server, and/or other user devices or appliances may be carried using any type of wired or wireless connection and using any suitable type of communication network, non-limiting examples of which are provided below. For example, cloud server may be in direct or indirect communication with oven appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 182 is described herein according to an exemplary embodiment of the present subject matter. However, it should be appreciated that the exemplary functions and configurations of external communication system 182 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

In some embodiments, cloud server can store or include one or more machine-learned models (e.g., as identified generally by reference numeral 60). As examples, the machine-learned model(s) 60 can be or can otherwise include various machine-learned models such as, for example, neural networks (e.g., deep neural networks, etc.), support vector machines, decision trees, ensemble models, k-nearest neighbors models, Bayesian networks, logistics models, gradiant boost models, XGBoost models, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks. The machine-learned models of the cloud server may be used to analyze the appliance data transmitted from the oven appliance 100. Additionally or alternatively, cloud server can train the machine-learned models through use of a model trainer (e.g., training algorithm), as would be understood. For example, as explained above, these models may include supervised models (e.g., trained or targeted toward certain problems or occurrences) and/or unsupervised models and methods (e.g., used to detect clusters of data similarities). Optionally, such a model trainer may train machine-learned models based on a set of training data compiled from a plurality of different appliances, appliance models, etc.

Cloud server may include a network interface to facilitate communication over one or more networks (e.g., network 174) with one or more network nodes. Network interface can be an onboard component or it can be a separate, off board component. In turn, cloud server can exchange data with one or more nodes over the network 174. Furthermore, it is understood that cloud server may further exchange data with any number of client devices over a network such as network 174. The client devices (e.g., such as remote device 184) can be any suitable type of computing device, such as a general purpose computer, special purpose computer, laptop, desktop, integrated circuit, mobile device, smartphone, tablet, or another suitable computing device. Information, signals, or other data (e.g., relating to appliance performance, fault conditions, analyzation results, inputs/outputs of machine-learned models, etc.) may thus be exchanged between oven appliance 100 and various separate client devices (e.g., a user's mobile phone) through cloud server.

Referring now specifically to FIG. 2, the operation of oven appliance 100 is controlled by a processing device or controller 170. As shown, controller 170 is communicatively coupled with control panel 164 and its user inputs 166. Controller 170 may also be communicatively coupled with various operational components of oven appliance 100 as well, such as heating assembly 140, e.g., heating element 142, knobs 162, temperature sensors, cameras, speakers, and microphones 224, etc. Input/output (“I/O”) signals may be routed between controller 170 and the various operational components of oven appliance 100. Thus, controller 170 can selectively activate and operate these various components. Various components of oven appliance 100 are communicatively coupled with controller 170 via one or more communication lines 172, such as, e.g., signal lines, shared communication busses, or wirelessly.

Controller 170 includes one or more memory devices and one or more processors (not labeled). The processors can be any combination of general or special purpose processors, CPUs, or the like that can execute programming instructions or control code associated with operation of oven appliance 100. The memory devices may represent random access memory such as DRAM or read only memory such as ROM or FLASH. In one embodiment, the processor executes programming instructions stored in memory. The memory may be a separate component from the processor or may be included onboard within the processor. Alternatively, controller 170 may be constructed without using a processor, e.g., using a combination of discrete analog and/or digital logic circuitry (such as switches, amplifiers, integrators, comparators, flip-flops, AND gates, and the like) to perform control functionality instead of relying upon software. Controller 170 may include a network interface such that controller 170 can connect to and communicate over one or more networks with one or more network nodes. Controller 170 can also include one or more transmitting, receiving, and/or transceiving components for transmitting/receiving communications with other devices communicatively coupled with oven appliance 100. Additionally or alternatively, one or more transmitting, receiving, and/or transceiving components can be located off board controller 170. Controller 170 can be positioned in a variety of locations throughout oven appliance 100. For this embodiment, controller 170 is located proximate user interface panel 160 toward top portion 132 of oven appliance 100.

Control panel 164, including user inputs 166 and display 168, and knobs 162 collectively make up a user interface 180 of oven appliance 100. User interface 180 provides a means for users to communicate with and operate oven appliance 100. It will be appreciated that other components or devices that provide for communication with oven appliance 100 for operating oven appliance 100 may also be included in user interface. For example, user interface 180 may include a speaker, a microphone 224, a camera or motion detection camera for detecting a user's proximity to oven appliance 100 or for picking up certain motions, and/or other user interface elements in various combinations.

Referring now to FIGS. 3 through 5, microphone mounting assembly 200 will be described in more detail according to example embodiments of the present subject matter. More specifically, according to example embodiments, oven appliance 100 may include a microphone mounting assembly 200 that is positioned adjacent to, apart of, embedded in, in place of, and/or synonymous with the user interface panel 160. Microphone mounting assembly 200 is generally configured for receiving audio inputs from a user of oven appliance 100. In this regard, for example, microphone mounting assembly 200 includes a glass panel 210 that is usually placed on the front of the oven appliance 100 and toward top portion 132 of oven appliance 100. For example, glass panel 210 may be a portion of the microphone mounting assembly 200 and/or user interface panel 160 that is visible to a user oven appliance 100.

According still to other embodiments, glass panel 210 may define and/or include at least one microphone hole slot 214. The at least one microphone hole slot 214 allows for audio signals, in the form of sound waves, from a user to reach at least one microphone 224 unimpeded.

In some embodiments, the at least one microphone hole slot 214 is a plurality of microphone hole slots 214. In this regard, the at least one microphone 224 is a plurality of microphones 224. In another example embodiment, glass panel 210 may further define and/or include a display screen slot 216 located proximate to the center of glass panel 210. The display screen slot 216 allows for a display screen 226, which enables the display 168 mentioned above, to be coupled thereto and positioned therein.

Microphone mounting assembly 200 further includes a back panel 212 coupled to glass panel 210. Although illustrated as user interface panel 160, back panel 212 is positioned in the behind glass panel 212 when viewing the front of oven appliance 100 (FIG. 1) and to the right of glass panel 212 when viewing the second (right) side of oven appliance 100 (FIG. 2). Back panel 212 defines a printed circuit board cutout 218. Printed circuit board cutout 218 is configured to receive a printed circuit board 222 therein. The printed circuit board 222 is configured to receive at least one microphone 224 and is coupled to back panel 212 positioned within the printed circuit board cutout 218. The at least one microphone 224 is coupled to the printed circuit board 222 and also positioned within the printed circuit board cutout 218.

As illustrated in FIG. 4, back panel 212 may further define and/or include a display screen cutout 220. Display screen cutout 220 is configured to receive display screen 226, which enables the display 168 mentioned above, to be coupled thereto and positioned therein. Display screen 226 may be coupled to the back panel 212 positioned within the display screen cutout 220 and coupled to the glass panel 210 positioned within the display screen slot 216. Display screen 226 can be a touch sensitive component (e.g., a touch-sensitive display screen or a touch pad) that is sensitive to the touch of a user input object (e.g., a finger or a stylus). Display screen 226 may include one or more graphical user interfaces that allow for a user to select or manipulate various operational features of oven appliance 100 or its cooktop 150. Display 168 may be an LCD screen, LED screen, etc.

The printed circuit board cutout 218 may be positioned at any point along back panel 212. In one example embodiment, and as illustrated in FIG. 4, printed circuit board cutout 218 may be located between the center of back panel 212 and a distal end of back panel 212. In another example embodiment, the printed circuit board cutout 218 may be positioned adjacent to display screen cutout 220. In another example embodiment, printed circuit board cutout 218 may be positioned above or below display screen cutout 220.

Back panel 212 may be composed of a variety of materials. For example, back panel 212 may be a plastic laminate material that is impact resistant and durable, e.g., a high-pressure laminate material. In an alternative embodiment, back panel 212 may be a silicone rubber composite for its heat resistance and shock absorption properties. In another example embodiment, back panel 212 may be a high temperature thermoplastic elastomer and/or an ethylene propylene diene monomer rubber. In another example embodiment, back panel 212 may include a combination of materials including but not limited to the aforementioned materials.

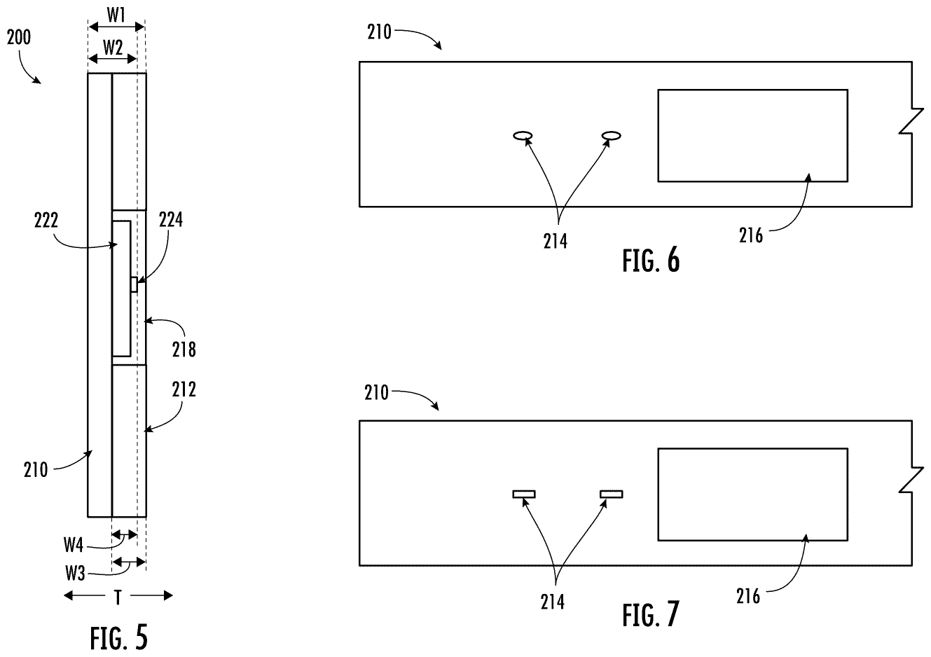

Referring now specifically to FIG. 5, a side sectional view of example microphone mounting assembly 200 is provided, defining various thicknesses. In one example embodiment, an assembly width W1 defined by a distance between a front of the glass panel 210 and a back of the back panel 212 is greater than a partial assembly width W2 defined by a distance between the front of the glass panel 210 and a back of the at least one microphone 224 coupled to the printed circuit board 222. This allows the printed circuit board 222 and microphone 224 to not extend past the back of back panel 212. However, in an alternative embodiment the printed circuit board 222 and microphone 224 may extend past the back of back panel 212.

Further, in one example embodiment of microphone mounting assembly 200, a printed circuit board cutout width W3 defined by a distance between a bottom of the printed circuit board cutout 218 and a top of the printed circuit board cutout 218 along the transverse direction T is greater than a printed circuit board assembly width W4 defined by a distance between the front of the printed circuit board 222 and a back of the at least one microphone 224 coupled to the printed circuit board 222 along the transverse direction T. This also allows the printed circuit board 222 and microphone 224 to not extend past the back of back panel 212. However, in an alternative embodiment the printed circuit board 222 and microphone 224 may extend past the back of back panel 212.

In one example embodiment, there is a ratio relationship between the diameter of the at least one microphone hole slot 214 and the assembly width W1 is approximately 1:2 or larger. In one example embodiment, glass panel 210 may have a width between 0.75 millimeters and 1.5 millimeters along the transverse direction T. In one example embodiment, back panel 212 may have a width between 1 millimeter and 4 millimeters along the transverse direction T. In one example embodiment, the assembly width W1 is between 1.75 millimeters and 5.5 millimeters along the transverse direction T.

Referring now to FIGS. 6 and 7, some alternative embodiments for the shape of the at least one microphone hole slots 214 are shown. For example, as shown in FIG. 6, the at least one microphone hole slots 214 may be generally oval shaped. The oval shaped description is inclusive of a circular shaped at least one microphone hole slot 214, as illustrated in FIG. 3. In an alternative embodiment, and as shown in FIG. 7, the at least one microphone hole slots 214 may be generally rectangular shaped.

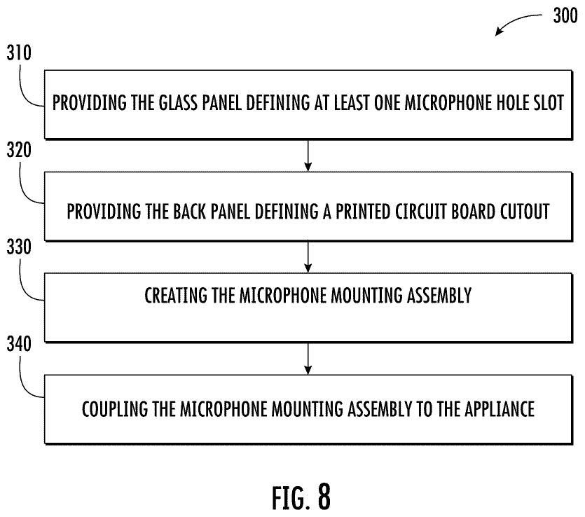

Referring now to FIG. 8, method 300 includes, at 310, providing the glass panel defining at least one microphone hole slot. As explained above, using oven appliance 100 as an example, the glass panel 210 will be on a front of oven appliance 100 and thus be user facing. The at least one microphone hole slots allow for audio signals, in the form of sound waves, from a user to reach at least one microphone 224 unimpeded.

Method 300 further includes, at 320, providing the back panel defining a printed circuit board cutout. As explained above, using oven appliance 100 as an example, back panel 212 may be comprised of any of the materials mentioned above. Back panel 212 will serve as a structural support to the microphone mounting assembly 200.

Method 300 further includes, at 330, creating the microphone mounting assembly. As will be explained in greater detail below and in following method steps, using oven appliance 100 as an example, creating microphone mounting assembly 200 includes coupling the at least one microphone 224 to the printed circuit board 222, coupling the printed circuit board 222 to the back panel 212, and coupling the back panel 212 to the glass panel 210.

Method 300 further includes, at 340, coupling the microphone mounting assembly to the appliance. Using oven appliance 100 as an example, microphone mounting assembly 200 may be coupled to the upper front portion 107 of the oven appliance 100. This coupling may be a result of mechanical fasteners, e.g., screws, bolts, clamps, snaps, etc.

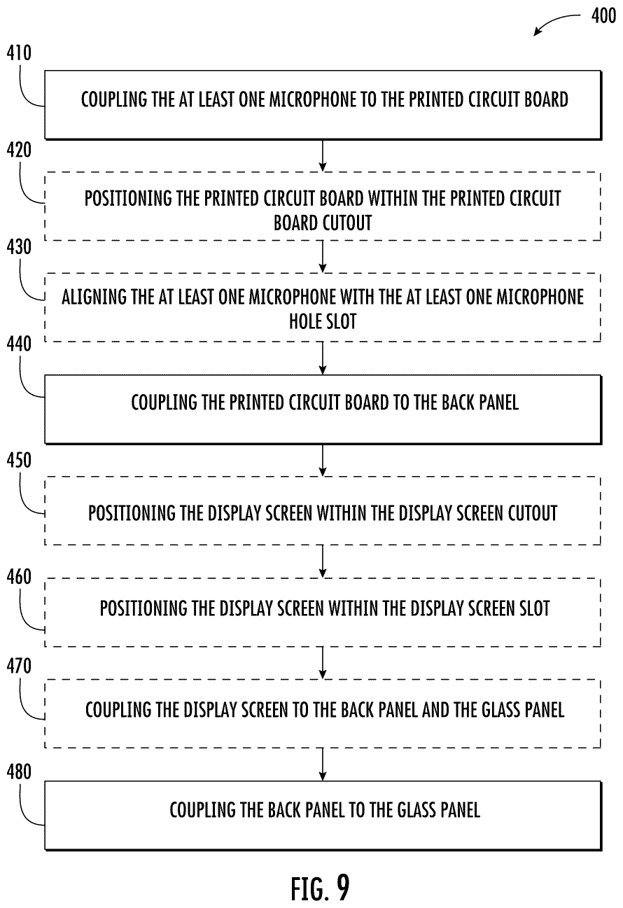

Referring now to FIG. 9, method 400 is a method for creating a microphone mounting assembly and includes, at 410, coupling the at least one microphone to the printed circuit board. As explained above, using oven appliance 100 as an example, printed circuit board 218 is configured to receive at least one microphone 224. This may be achieved through a variety of means, including surface mount technology, through hole mounting, flex circuit connection, and wire connection.

Method 400 may further include, at 420, positioning the printed circuit board within the printed circuit board cutout. As explained above, using oven appliance 100 as an example, printed circuit board cutout 218 is configured to receive printed circuit board 222. The printed circuit board cutout width W3 is greater than the width of the printed circuit board along the transverse direction.

Method 400 may further include, at 430, aligning the at least one microphone with the at least one microphone hole slot. Using oven appliance 100 as an example, aligning the at least one microphone 224 with the at least one microphone hole slot 214 ensures that the audio input from the user reach the at least one microphone unimpeded. Further, in one embodiment, the at least one microphone hole slot 214 is a plurality of microphone hole slots 214, and the at least one microphone 224 is a plurality of microphones 224. In this embodiment, the plurality of microphones 224 and plurality of microphone hole slots 214 being align helps further ensure tight tolerances are adhered to during the manufacturing process.

Method 400 further includes, at 440, coupling the printed circuit board to the back panel. As explained above, using oven appliance 100 as an example, the printed circuit board 222 including the at least one microphone 224 coupled thereto are positioned within the printed circuit board cutout 218 on back panel 212. In this example embodiment, the printed circuit board cutout width W3 is greater than the printed circuit board assembly width W4.

Method 400 may further include, at 450, positioning the display screen within the display screen cutout. As explained above, using oven appliance 100 as an example, microphone mounting assembly may include a display screen 226. In this embodiment, the back panel 212 includes a display screen cutout 220. Display screen 226 may be communicatively coupled to controller 164 and/or printed circuit board 222.

Method 400 may further include, at 460, positioning the display screen within the display screen slot. As explained above, using oven appliance 100 as an example, microphone mounting assembly may include a display screen 226. In this embodiment, the glass panel 210 includes a display screen slot 216. Display screen 226 may be communicatively coupled to controller 164 and/or printed circuit board 222.

Method 400 may further include, at 470, coupling the display screen to the back panel and the glass panel. As explained above, using oven appliance 100 as an example, microphone mounting assembly may include a display screen 226. In this embodiment, display screen is positioned within the display screen cutout 220 of back panel 212 and the display screen slot 216 of glass panel 210. This coupling may be a result of mechanical fasteners, e.g., screws, bolts, clamps, snaps, etc.

Method 400 further includes, at 480, coupling the back panel to the glass panel. As explained above, using oven appliance 100 as an example, microphone mounting assembly includes the glass panel 210 and back panel 212 coupled to the glass panel. This coupling allows the printed circuit board 222 with the at least one microphone 224 coupled thereto along with the display screen 226, if present, to have their movement restricted. This coupling may be a result of mechanical fasteners, e.g., screws, bolts, clamps, snaps, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance defining a mutually orthogonal vertical direction, lateral direction, and transverse direction, the appliance comprising:
a cabinet defining a chamber;
a cabinet door; and
a microphone mounting assembly comprising:
a glass panel defining at least one microphone hole slot;
a back panel coupled to the glass panel defining a printed circuit board cutout;
a printed circuit board configured to receive at least one microphone coupled to the back panel positioned within the printed circuit board cutout; and
at least one microphone coupled to the printed circuit board positioned within the printed circuit board cutout.

2. The appliance of claim 1, wherein the glass panel further defines a display screen slot.

3. The appliance of claim 2, wherein the back panel further defines a display screen cutout.

4. The appliance of claim 3, the microphone mounting assembly further comprising:
a display screen coupled to the back panel positioned within the display screen cutout and coupled to the glass panel positioned within the display screen slot.

5. The appliance of claim 1, wherein the glass panel has a width between 0.75 millimeters and 1.5 millimeters along the transverse direction.

6. The appliance of claim 1, wherein the back panel has a width between millimeter and 4 millimeters along the transverse direction.

7. The appliance of claim 1, wherein the back panel is a plastic laminate material.

8. The appliance of claim 1, wherein an assembly width defined by a distance between a front of the glass panel and a back of the back panel is greater than a partial assembly width defined by a distance between the front of the glass panel and a back of the at least one microphone coupled to the printed circuit board.

9. The appliance of claim 1, wherein a printed circuit board cutout width defined by a distance between a bottom of the printed circuit board cutout and a top of the printed circuit board cutout along the transverse direction is greater than a printed circuit board assembly width defined by a distance between the front of the printed circuit board and a back of the at least one microphone coupled to the printed circuit board along the transverse direction.

10. The appliance of claim 1, wherein the at least one microphone hole slot is generally oval shaped.

11. The appliance of claim 1, wherein the at least one microphone hole slot is a plurality of microphone hole slots, and wherein the at least one microphone is a plurality of microphones.

12. A method for assembling an appliance, the appliance comprising a cabinet defining a chamber, a cabinet door, and a microphone mounting assembly comprising a glass panel defining at least one microphone hole slot, a back panel coupled to the glass panel defining a printed circuit board cutout, a printed circuit board configured to receive at least one microphone coupled to the back panel positioned within the printed circuit board cutout, and at least one microphone coupled to the printed circuit board; the method comprising:
providing the glass panel defining at least one microphone hole slot;
providing the back panel defining a printed circuit board cutout;
creating the microphone mounting assembly; and
coupling the microphone mounting assembly to the appliance.

13. The method of claim 12, wherein creating the microphone mounting assembly comprises:
coupling the at least one microphone to the printed circuit board;
coupling the printed circuit board to the back panel; and
coupling the back panel to the glass panel.

14. The method of claim 13, wherein the glass panel further defines a display screen slot, and wherein the back panel further defines a display screen cutout.

15. The method of claim 14, wherein the appliance further comprises:
a display screen coupled to the back panel positioned within the display screen cutout and coupled to the glass panel positioned within the display screen slot.

16. The method of claim 15, wherein creating the microphone mounting assembly further comprises:
positioning the display screen within the display screen cutout; and
positioning the display screen within the display screen slot.

17. The method of claim 15, wherein creating the microphone mounting assembly further comprises:
coupling the display screen to the back panel and the glass panel.

18. The method of claim 13, wherein creating the microphone mounting assembly further comprises:
positioning the printed circuit board within the printed circuit board cutout.

19. The method of claim 13, wherein creating the microphone mounting assembly further comprises:
aligning the at least one microphone with the at least one microphone hole slot.

20. The method of claim 13, wherein the glass panel has a width between 0.75 millimeters and 1.5 millimeters along the transverse direction, and wherein the back panel has a width between 1 millimeters and 4 millimeters along the transverse direction.
